(19) United States
(12) Patent Application Publication
(10) Pub. No.: US 2019/0025506 A1
(43) Pub. Date: Jan. 24, 2019

(54) POLARIZATION SPLITTER ROTATOR

(71) Applicant: Finisar Corporation, Sunnyvale, CA (US)

(72) Inventor: Bryan Park, Sunnyvale, CA (US)

(21) Appl. No.: 16/037,905

(22) Filed: Jul. 17, 2018

Related U.S. Application Data
(60) Provisional application No. 62/534,088, filed on Jul. 18, 2017.

(51) Int. Cl. G02B 6/126; G02B 6/122; G02B 6/125

(52) U.S. Cl. CPC G02B 6/126; G02B 2006/12061; G02B 6/125; G02B 6/1228

(57) ABSTRACT

In an example, a photonic system includes a Si PIC-based polarization splitter rotator (PSR) that includes first and second SiN waveguides formed in a first layer of a Si PIC, each of the first and second SiN waveguides having a coupler portion. The PSR also includes a Si waveguide formed in a second layer of the Si PIC above or below the first layer. The Si waveguide includes a first tapered end near the coupler portion of the first SiN waveguide and adiabatically coupled to the coupler portion of the first SiN waveguide, a second tapered end near the coupler portion of the second SiN waveguide and adiabatically coupled to the coupler portion of the second SiN waveguide, and a first s-bend between the first and second tapered ends that cooperates with the first SiN waveguide to form a polarization rotator for light propagating in the first SiN waveguide.

### CROSS-REFERENCE TO RELATED APPLICATION

This application claims the benefit of and priority to U.S. Provisional Application No. 62/534,088, filed Jul. 18, 2017. The 62/534,088 application is incorporated herein by reference in its entirety.

This application is related to U.S. Pat. No. 9,405,066, issued on Aug. 2, 2016 (hereinafter the '066 patent). The '066 patent is incorporated herein by reference in its entirety.

### FIELD

The embodiments discussed herein are related to a polarization splitter rotator.

### BACKGROUND

Unless otherwise indicated herein, the materials described herein are not prior art to the claims in the present application and are not admitted to be prior art by inclusion in this section.

The '066 patent describes various two-stage adiabatically coupled optical systems. Such systems may include a silicon (Si) photonic integrated circuit (PIC) polarization splitter or combiner. The Si PIC polarization splitter of the '066 patent may output two orthogonal polarization channels.

The subject matter claimed herein is not limited to implementations that solve any disadvantages or that operate only in environments such as those described above. Rather, this background is only provided to illustrate one example technology area where some implementations described herein may be practiced.

### SUMMARY

Some embodiments discussed herein are related to a polarization splitter rotator.

In an example embodiment, a photonic system includes a Si PIC-based polarization splitter rotator (PSR). The PSR may include a first silicon nitride (SiN) waveguide formed in a first layer of a Si PIC, the first SiN waveguide having a coupler portion. The PSR may include a second SiN waveguide formed in the first layer of the Si PIC, the second SiN waveguide having a coupler portion. The PSR may include a Si waveguide formed in a second layer of the Si PIC that is above or below the first layer. The Si waveguide may include a first tapered end near the coupler portion of the first SiN waveguide and adiabatically coupled to the coupler portion of the first SiN waveguide. The Si waveguide may also include a second tapered end near the coupler portion of the second SiN waveguide and adiabatically coupled to the coupler portion of the second SiN waveguide. The Si waveguide may also include a first s-bend between the first and second tapered ends that cooperates with the first SiN waveguide to form a polarization rotator for light propagating in the first SiN waveguide.

In another example embodiment, a method may include receiving an optical signal that includes a first component with a first polarization and a second component with a second polarization that is orthogonal to the first polarization at a coupler portion of a first SiN waveguide formed in a first layer of a Si PIC. The method may also include adiabatically coupling the second component from the coupler portion of the first SiN waveguide into a first tapered end of a Si waveguide formed in a second layer of the Si PIC that is above or below the first layer while transmitting the first component through the coupler portion of the first SiN waveguide. The method may also include rotating the polarization of the first component from the first polarization to the second polarization by transmitting the first component through a portion of the first SiN waveguide that is positioned at least partially above an s-bend formed in the Si waveguide. The method may also include adiabatically coupling the second component from a second tapered end of the Si waveguide that is opposite the first tapered end of the Si waveguide into a coupler portion of a second SiN waveguide formed in the first layer of the Si PIC.

In another example embodiment, a photonic system includes a PSR. The PSR may include a polarization splitter, a polarization rotator, and a TM mode filter. The polarization splitter may have an input, a first output for a TM channel, and a second output for a TE channel. The polarization rotator may be optically coupled to the first output of the polarization splitter. The TM mode filter may be optically coupled to the second output of the polarization splitter.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only typical embodiments of the disclosure and are therefore not to be considered limiting of its scope. The disclosure will be described and explained with additional specificity and detail through the use of the accompanying drawings in which:

FIG. 1 illustrates a cross-sectional view of an example optical system that includes a two stage adiabatic coupler;

FIG. 2 illustrates an example embodiment of a demultiplexer system that may be implemented in the optical system of FIG. 1;

FIG. 3 illustrates an example PSR that may be implemented in the demultiplexer system of FIG. 2;

FIGS. 4A and 4B include graphical representations of some simulations associated with a Si-SiN adiabatic coupler of FIG. 3;

FIG. 5 includes graphical representations of some simulations associated with the PSR of FIG. 3;

FIG. 6 illustrates an example of a second s-bend of a Si waveguide of FIG. 3;

FIG. 7 includes simulated mode profiles for the second s-bend of FIG. 3 at the input to the second s-bend;

FIG. 8 includes simulated bend mode profiles for the second s-bend of FIG. 3 in a first arc of the second s-bend; and

FIG. 9 includes simulations associated with the PSR of FIG. 3,

all arranged in accordance with at least one embodiment described herein.

### DETAILED DESCRIPTION OF SOME EXAMPLE EMBODIMENTS

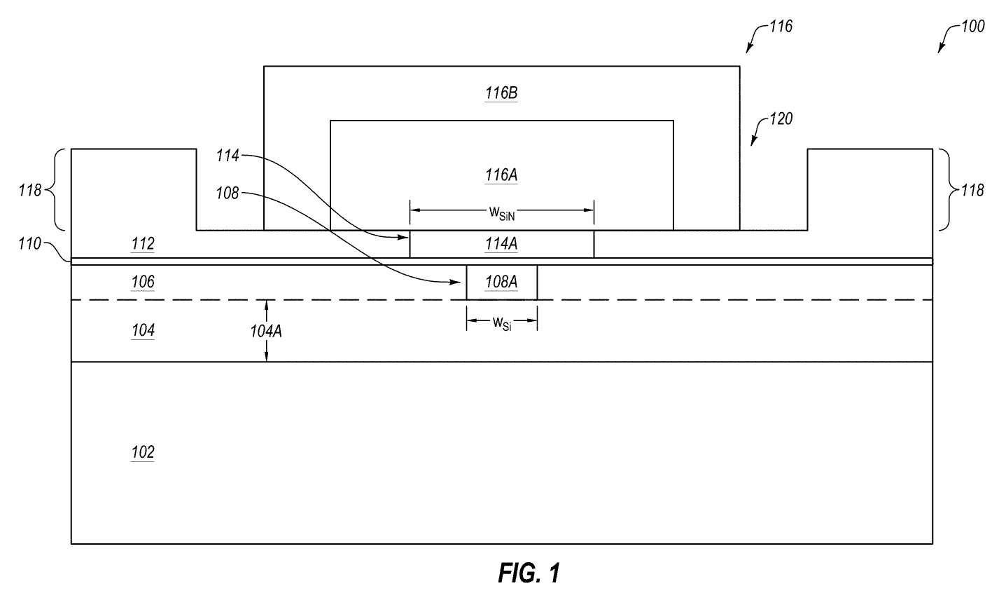

FIG. 1 illustrates a cross-sectional view of an example optical system 100 that includes a two stage adiabatic coupler, arranged in accordance with at least one embodiment described herein. The optical system 100 is one example optical system in which a Si PIC polarization splitter rotator as disclosed in the instant application may be implemented.

In more detail, FIG. 1 illustrates an example general stackup of layers of the optical system 100. The optical system 100 of FIG. 1 may include a Si substrate 102, a buried oxide (BOX) layer 104 formed on the Si substrate 102, a Si waveguide layer 106 formed on the BOX layer 104 and that includes one or more Si waveguides 108, a silicon nitride (SiN) slab 110 formed on the Si waveguide layer 106, a SiN waveguide layer 112 formed on the SiN slab 110 and that includes one or more SiN waveguides 114, one or more polymer waveguides 116 included in a polymer interposer, and one or more dielectric layers 118 formed on the SiN waveguide layer 112. Alternatively, the one or more polymer waveguides 116 and polymer interposer may be substituted for one or more high index glass waveguides included in a high index glass interposer, or other suitable interposer waveguides and interposer. All of the foregoing components except for the interposer (including the polymer waveguides 116 in this example) may collectively form a Si PIC.

The '066 patent discloses various example details of elements included in the optical system 100 as well as various alternative arrangements (e.g., different order of layers) and/or other embodiments. The embodiments disclosed herein may be implemented in combination with none or one or more of the details, alternative arrangements, and/or other embodiments of the '066 patent.

Each of the Si waveguides 108 includes a Si core 108A and a cladding. The cladding of each of the Si waveguides 108 may include, e.g., silicon dioxide (SiO₂) or other suitable material that may be included in the Si waveguide layer 106. Each of the SiN waveguides 114 includes a SiN core 114A and a cladding. The cladding of each of the SiN waveguides 114 may include, e.g., SiO₂ or other suitable material that may be included in the SiN waveguide layer 112. Each of the polymer waveguides 116 includes a polymer core 116A and a polymer cladding 116B.

One or more Si waveguides 108 in the Si waveguide layer 106 may be adiabatically coupled to one or more corresponding SiN waveguides 114 in the SiN waveguide layer 112. Analogously, one or more SiN waveguides 114 in the SiN waveguide layer 112 may be adiabatically coupled to one or more corresponding polymer waveguides 116 in the polymer interposer. The combination of a Si waveguide adiabatically coupled to a SiN waveguide may be referred to as a Si-SiN adiabatic coupler while the combination of a SiN waveguide adiabatically coupled to a polymer or other interposer waveguide may be referred to as a SiN-interposer adiabatic coupler. Light may propagate in either direction through a corresponding adiabatic coupler. For example, light may propagate in a Si-SiN adiabatic coupler from the Si waveguide 108 to the SiN waveguide 114 or from the SiN waveguide 114 to the Si waveguide 108. Analogously, light may propagate in a SiN-interposer waveguide from the SiN waveguide 114 to the interposer waveguide (e.g., the polymer waveguide 116 in FIG. 1) or from the interposer waveguide to the SiN waveguide 114.

The optical system 100 of FIG. 1 may be described as including a two stage adiabatic coupler insofar as light may be adiabatically coupled from one of the Si waveguides 108 to one of the polymer waveguides 116, or vice versa, through two adiabatic couplers in sequence. Embodiments described herein may more generally be implemented in optical systems with one or more stages of adiabatic couplers.

Adiabatic coupling as used herein is as described in the '066 patent. In general, the SiN waveguide 114, and more particularly the SiN core 114A, may have a tapered section to adiabatically couple light from the SiN waveguide 114 into the polymer waveguide 116, or vice versa, as described in more detail in the '066 patent. Similarly, in general, the Si waveguide 108, and more particularly the Si core 108A, may have a tapered section to adiabatically couple light from the Si waveguide 108 into the SiN waveguide 114, or vice versa, as described in more detail in the '066 patent.

The thicknesses or other dimensions of the layers and/or elements of the optical system 100 may have any suitable values. Various examples are described in the '066 patent.

As disclosed in the '066 patent, the Si PIC polarization splitter or combiner of the '066 patent may include a combination of two SiN waveguides and a Si waveguide, such as two of the SiN waveguides 114 and one of the Si waveguides 108 of FIG. 1, in a particular arrangement. Embodiments described in the instant application relate to a different arrangement of two SiN waveguides and a Si waveguide, such as two of the SiN waveguides 114 and one of the Si waveguides 108 of FIG. 1, with various differences from the Si PIC polarization splitter or combiner of the '066 patent to form a polarization splitter rotator. Prior to describing an example embodiment of a polarization splitter rotator in detail, an example operating environment for such a polarization splitter rotator will be described, followed by a summary of various principles related to the design of the Si PIC polarization splitter rotators described herein.

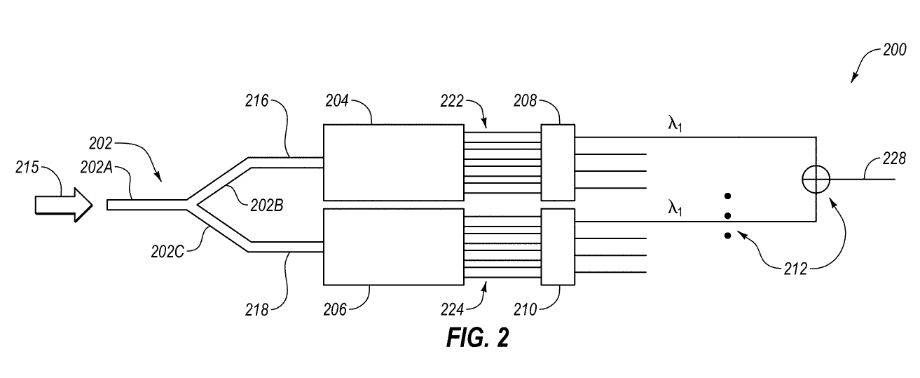

FIG. 2 illustrates an example embodiment of a demultiplexer system 200, arranged in accordance with at least one embodiment described herein. Some or all of the demultiplexer system 200 may be implemented in a Si PIC, such as the Si PIC described above in connection with FIG. 1. The demultiplexer system 200 includes a polarization splitter rotator 202 (hereinafter “PSR 202”), a first wavelength division multiplexing (WDM) demultiplexer (demux) 204, a second WDM demux 206, first opto-electrical transducers 208, second opto-electrical transducers 210, and adders 212 (only one of which is illustrated for simplicity). Additional adders 212 are denoted by ellipses in FIG. 2.

The PSR 202 in the demultiplexer system 200 includes an input 202A and first and second outputs 202B and 202C. As described in more detail below, the PSR 202 may generally include first and second SiN waveguides formed in a corresponding layer of a Si PIC and a Si waveguide with two tapered ends formed in another layer of the Si PIC above or below the layer in which the first and second SiN waveguides are formed. In some embodiments, the first and second WDM demuxes 204 and 206 may be formed in the same layer of the Si PIC as the first and second SiN waveguides of the PSR 202. For example, the first and second WDM demuxes 204 and 206 and the first and second SiN waveguides of the PSR 202 may all be formed in a SiN layer of a PIC.

The input 202A may include a first end of the first SiN waveguide, the first output 202B may include a second end of the first SiN waveguide, and the second output 202C may include a second end of the second SiN waveguide. At the input 202A, the PSR 202 may receive an input beam 215 that includes an N-channel optical signal (e.g., a multiplexed optical signal with N wavelength channels λ₁, λ₂, λ₃, . . . , λₙ) with two orthogonal polarizations, e.g., TE polarization and TM polarization. The input beam 215 may be split according to polarization, with a portion of the input beam 215 with TE polarization at the input 202A generally being outputted from the first or second output 202B or 202C and a portion of the input beam 215 with TM polarization at the input 202A generally being outputted from the other of the second or first output 202C or 202B.

The portions of the input beam 215 that include TE and TM polarization may be respectively referred to as the TE channel and the TM channel, without respect to their actual polarization at the first and second outputs 202B, 202C of the PSR 202. In some embodiments, the TM channel may have its polarization rotated by the PSR 202 such that it enters the PSR 202 with TM polarization and exits the PSR 202 with TE polarization, while still being referred to as the TM channel. Alternatively, the TE channel may have its polarization rotated by the PSR 202 such that it enters the PSR 202 with TE polarization and exits the PSR 202 with TM polarization, while still being referred to as the TE channel.

Each of the first and second WDM demuxes 204 and 206 may be optimized for and/or specific to one of the two polarizations depending on the polarization of light that is input to the first or second WDM demux 204 or 206. In an example implementation, both the TE channel and the TM channel may exit the PSR 202 with the TE polarization such that both the first WDM demux 204 and the second WDM demux 206 may be optimized for or specific to the TE polarization. Alternatively, both the TE channel and the TM channel may exit the PSR 202 with the TM polarization such that both the first WDM demux 204 and the second WDM demux 206 may be optimized for or specific to the TM polarization. In these and other embodiments, each of the first and second WDM demuxes 204 and 206 may include an Echelle grating with or without a polarization-dependent filter function.

The first WDM demux 204 includes an input 216 optically coupled to the first output 202B of the PSR 202. Analogously, the second WDM demux 206 includes an input 218 optically coupled to the second output 202C of the PSR 202.

The first WDM demux 204 additionally includes outputs 222 optically coupled to the first opto-electrical transducers 208. Analogously, the second WDM demux 206 additionally includes outputs 224 optically coupled to the second opto-electrical transducers 210. The first opto-electrical transducers 208 and the second opto-electrical transducers 210 may each include at least N PN diodes, avalanche photodiodes (APDs), or other suitable optical receivers.

The adders 212 are electrically coupled to outputs of the first and second opto-electrical transducers 208 and 210, where each of the adders 212 is electrically coupled to an output of a corresponding one of the first opto-electrical transducers 208 and to an output of a corresponding one of the second opto-electrical transducers 210. In particular, for i=1 to N, an ith one of the adders 212 may be electrically coupled to an ith one of the first opto-electrical transducers 208 and to an ith one of the second opto-electrical transducers 210 to sum an electrical output of the ith one of the first opto-electrical transducers 208 with an electrical output of the ith one of the second opto-electrical transducers 210 to generate an ith combined electrical output 228.

In FIG. 2, in operation, the first WDM demux 204 may receive the TM channel of the input beam 215 from the first output 202B of the PSR 202 and may demultiplex it into the N distinct wavelength channels λ₁, λ₂, λ₃, . . . , λₙ that are outputted to the first opto-electrical transducers 208. The first opto-electrical transducers 208 may each output an electrical signal representative of a corresponding one of the N distinct wavelength channels received at the corresponding one of the first opto-electrical transducers 208. Further, the second WDM demux 206 may receive the TE channel of the input beam 215 from the second output 202C of the PSR 202 and may demultiplex it into the N distinct wavelength channels λ₁, λ₂, λ₃, . . . , λₙ that are outputted to the second opto-electrical transducers 210. The second opto-electrical transducers 210 may each output an electrical signal representative of a corresponding one of the N distinct wavelength channels received at the corresponding one of the second opto-electrical transducers 210.

The adders 212 may then combine the appropriate outputs from the first and second opto-electrical transducers 208 and 210 to generate an ith combined electrical signal 228 that is representative of the ith wavelength channel from the input beam 215 received at the input 202A of the PSR 202. In particular, a first (or second, or third, or Nth) one of the ith combined electrical signals 228 includes a sum of the electrical output of a first (or second, or third, or Nth) one of the first electro-optical transducers 208 that is representative of a first (or second, or third, or Nth) one of the N distinct wavelength channels output by the first WDM demux 204 and the electrical output of a first (or second, or third, or Nth) one of the second electro-optical transducers 210 that is representative of a first (or second, or third, or Nth) one of the N distinct wavelength channels output by the second WDM demux 206.

By splitting the TE channel from the TM channel, demultiplexing each separately from the other, and then adding corresponding channels with the adders 212, the demultiplexer system 200 of FIG. 2 may eliminate or at least significantly reduce channel cross-talk that may arise in WDM demuxes with polarization-dependent filter functions.

Various considerations and parameters associated with Si PIC polarization splitters such as described in the '066 patent may also apply to PSRs, such as the PSR 202 of FIG. 2. A summary of some of these considerations and parameters will be discussed followed by a discussion of at least one example PSR.

First, in Si and SiN waveguides of Si-SiN adiabatic couplers, the effective index for TE and TM polarizations in the SiN waveguide may not vary with Si waveguide width. The effective index for TE in the Si waveguide may be significantly lower than the effective index for TM in the Si waveguide at least for Si waveguide widths at least in a range from about 130 nanometers (nm) to about 180 nm. As such, TE and TM polarizations will necessarily have different coupling efficiencies in the Si-SiN adiabatic coupler if a tip width of a tapered end of the Si waveguide is between about 130 nm to 180 nm. More particularly, Si-SiN adiabatic couplers where the Si tip width is between about 130 nm to 180 nm may have much better coupling efficiency for TE polarization than for TM polarization

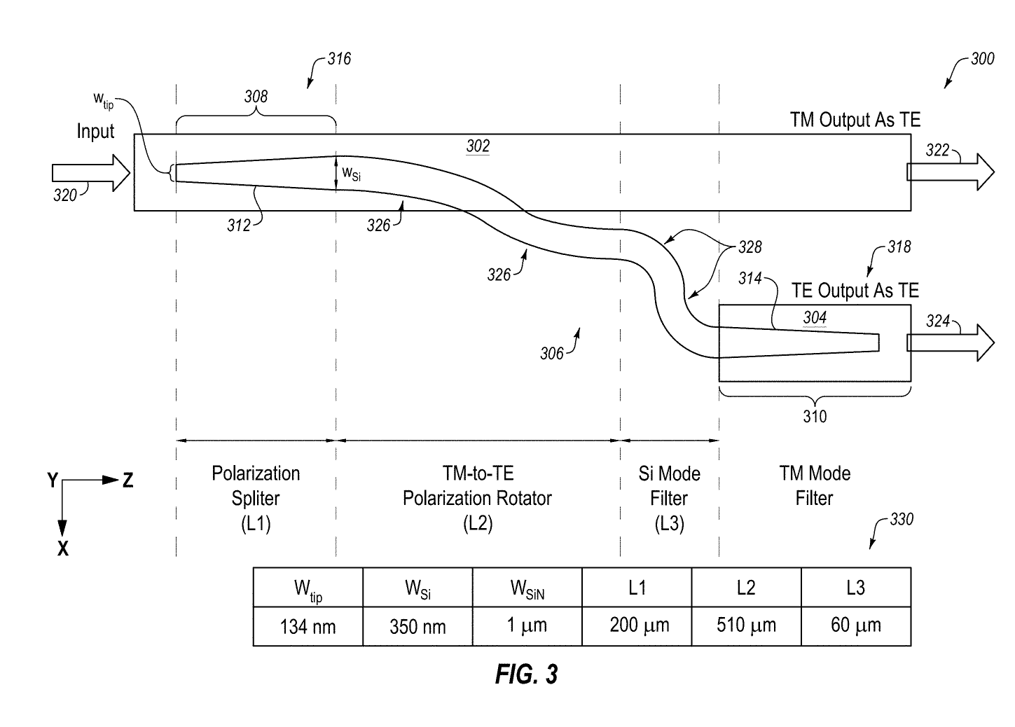

Thus, at least in some embodiments, a Si-SiN adiabatic coupler that includes a Si waveguide with a tip width between 130 nm to 180 nm may be used to selectively couple most of the TE polarization from the Si waveguide to the SiN waveguide (or vice versa) without coupling most of the TM polarization from the Si waveguide to the SiN waveguide (or vice versa). Two or more Si-SiN adiabatic couplers may be combined as described in more detail with respect to, e.g., FIG. 3 to form a PSR, such as the PSR 202 discussed above.

FIG. 3 illustrates an example PSR 300, arranged in accordance with at least one embodiment described herein. The PSR 300 may include or correspond to the PSR 202 of FIG. 2 and may be implemented in the demultiplexer system 200 of FIG. 2 and/or in other systems or devices.

FIG. 3 includes an overhead view of the PSR 300. The overhead view of FIG. 3 includes outlines or footprints of various components of the PSR 300 at different levels in a material stack up of the PSR 300 that may not necessarily be visible when viewed from above, but are shown as outlines or footprints to illustrate lateral (e.g., x) and longitudinal (e.g., z) alignment of the various components with respect to each other.

The PSR 300 includes a first SiN waveguide 302, a second SiN waveguide 304 spaced apart from the first SiN waveguide 302, and a Si waveguide 306. The first and second SiN waveguides 302 and 304 may be formed in a SiN waveguide layer of a Si PIC, such as in the SiN waveguide layer 112 of FIG. 1. The Si waveguide 306 may be formed in a Si waveguide layer of the Si PIC that is above or below the SiN waveguide layer of the Si PIC, such as in the Si waveguide layer 106 of FIG. 1.

The first SiN waveguide 302 includes a coupler portion 308, the second SiN waveguide 304 includes a coupler portion 310, and the Si waveguide 306 includes a first tapered end 312 and a second tapered end 314. The first tapered end 312 is aligned in two orthogonal directions (e.g., x and z) with the coupler portion 308 of the first SiN waveguide 302 such that the first tapered end 312 overlaps in the two orthogonal directions and is parallel to the coupler portion 308 of the first SiN waveguide 302, while being displaced therefrom in a vertical or y direction that is orthogonal to each of the x and z directions. The first tapered end 312 and the coupler portion 308 of the first SiN waveguide 302 may generally form a first Si-SiN adiabatic coupler 316. The first Si-SiN adiabatic coupler 316 may alternatively or additionally be referred to as a polarization splitter as denoted in FIG. 3, as it may generally perform a polarization splitting function. In particular, the first Si-SiN adiabatic coupler 316 or polarization splitter may separate two orthogonal polarizations of an input beam 320 such that one of the polarizations primarily propagates in the first SiN waveguide 302 and the other of the polarizations primarily propagates in the Si waveguide 306.

Analogously, the second tapered end 314 is aligned in two orthogonal directions (e.g., x and z) with the coupler portion 310 of the second SiN waveguide 304 such that the second tapered end 314 overlaps in the two orthogonal directions and is parallel to the coupler portion 310 of the second SiN waveguide 304, while being displaced therefrom in the vertical or y direction. The second tapered end 314 and the coupler portion 310 of the second SiN waveguide 304 may generally form a second Si-SiN adiabatic coupler 318. The second Si-SiN adiabatic coupler 318 may alternatively or additionally be referred to as a TM mode filter as denoted in FIG. 3, as it may generally perform a TM mode filtering function. For instance, any TM polarization that passes through the first Si-SiN adiabatic coupler 316 into the Si waveguide 306 may be substantially blocked or filtered by the second Si-SiN adiabatic coupler 318 from transferring into the second SiN waveguide 304.

Each of the first and second tapered ends 312 and 314 of the Si waveguide 306 may be configured to adiabatically couple most of a first polarization (e.g., TE polarization) of the input beam 320 between a corresponding one of the first and second tapered ends 312 and 314 of the Si waveguide 306 and a corresponding one of the first and second SiN waveguides 302 and 304 and to prevent most of a second polarization (e.g., TM polarization) of the input beam 320 that is orthogonal to the first polarization from being adiabatically coupled between the corresponding one of the first and second tapered ends 312 and 314 and the corresponding one of the first and second SiN waveguides 302 and 304. The foregoing may be accomplished by providing each of the first and second tapered ends 312 and 314 of the Si waveguide 306 with an appropriate tip width that generally discriminates between the first and second polarizations.

In more detail, the first tapered end 312 of the Si waveguide 306 may have a tip width configured to adiabatically couple most of the first polarization from the first SiN waveguide 302 through the first tapered end 312 to the Si waveguide 306 and to prevent most of the second polarization from entering the Si waveguide 306. For example, the first tapered end 312 may have a tip width in a range between 130 nm and 180 nm, such as about 134 nm. As a result, the portion of the input beam 320 with the second polarization (e.g., the TM polarization) may continue propagating in the first SiN waveguide 302 past the first Si-SiN adiabatic coupler 316 to be output as a TM channel 322 in this example, whereas the portion of the input beam 320 with the first polarization (e.g., the TE polarization) may be directed from the first SiN waveguide 302 into the Si waveguide 306.

Analogously, the second tapered end 314 of the Si waveguide 304 may have a tip width configured to adiabatically couple most of a portion of the first polarization propagating through the Si waveguide 306 from the Si waveguide 306 through the second tapered end 314 to the second SiN waveguide 304 and to prevent most of a portion of the second polarization propagating through the Si waveguide 306 from entering the second SiN waveguide 304. For example, the second tapered end 314 may have a tip width in a range between 130 nm and 180 nm, such as about 134 nm. As a result, the portion of the input beam 320 with the first polarization (e.g., the TE polarization) may be transferred from the Si waveguide 306 into the second SiN waveguide 304 to be output as a TE channel 324 in this example, whereas any portion of the light in the Si waveguide 306 with the second polarization (e.g., the TM polarization) may be blocked from transferring into the second SiN waveguide 304. Thus, the TM mode filter may improve a TE to TM polarization extinction ratio in the second SiN waveguide 304.

Accordingly, a tip width of the first and second tapered ends 312 and 314 may be configured to selectively couple most of the first polarization of the input beam 320 from the first SiN waveguide 302 to the second SiN waveguide 304 without coupling most of the second polarization from the first SiN waveguide 302 to the second SiN waveguide 304.

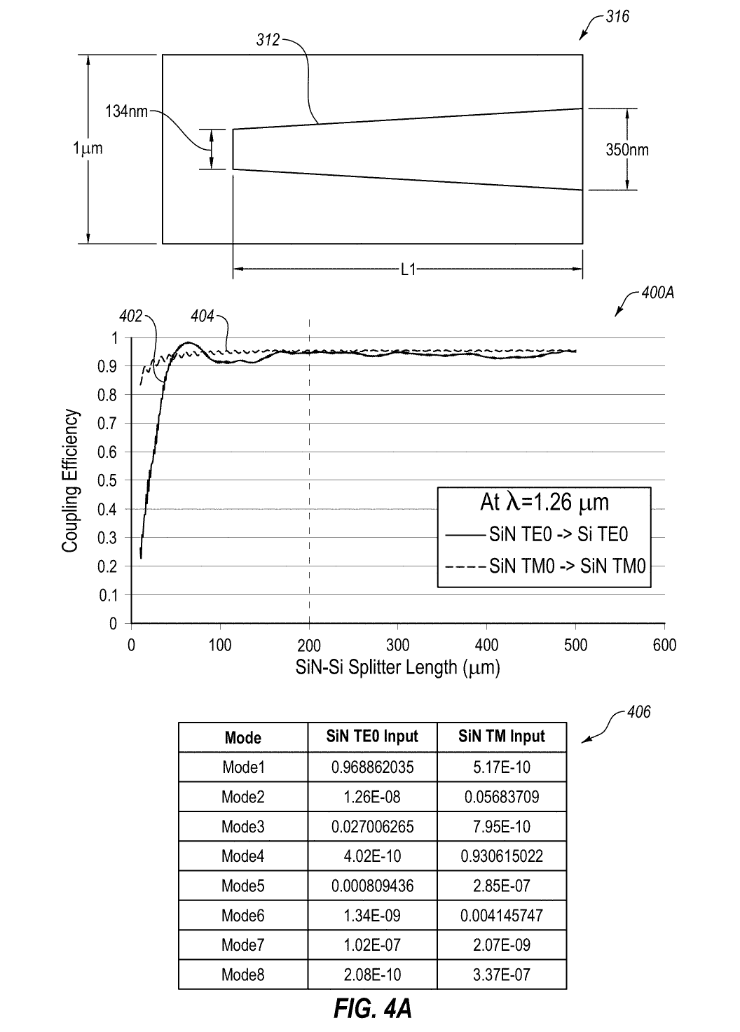

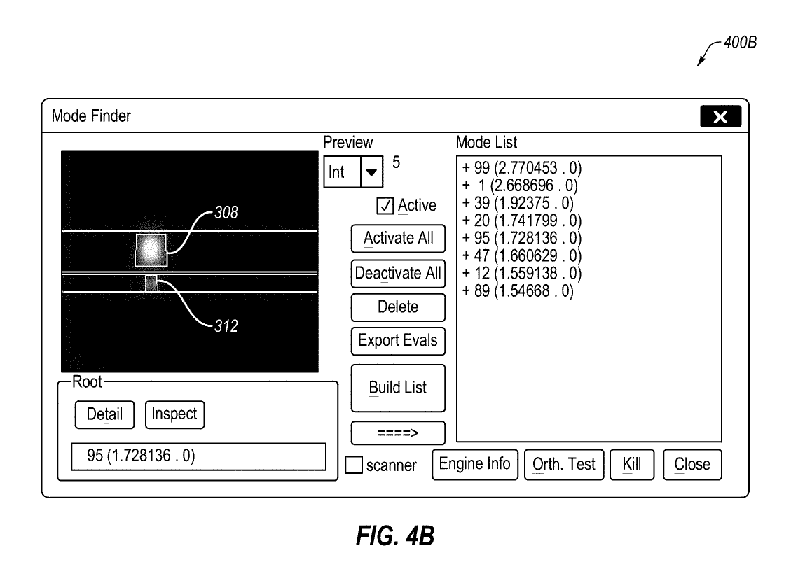

In the example of FIG. 3, the Si waveguide 306 may have a taper length of 200 μm (e.g., each of the first and second tapered ends 312 and 314 may be 200 μm long in a light propagation direction, e.g., the z direction in FIG. 3) and each of the first and second tapered ends 312 and 314 may have a tip width of 134 nm. In other embodiments, the first and second tapered ends 312 and 314 may have different taper lengths and/or different tip widths. For example, the Si waveguide 306 may have a taper length of at least 40 μm, or a taper length in a range from about 170 μm to 240 μm, or any suitable length to have TE and TM polarization coupling efficiency of at least 90% (see discussion of FIGS. 4A and 4B) or of about 95% or higher.

As illustrated in FIG. 3, the Si waveguide 306 may further include a first s-bend 326 and a second s-bend 328 optically coupled in series between the first and second tapered ends 312 and 314. The portion of the first SiN waveguide 302 that overlaps in the z direction the first s-bend 326 of the Si waveguide 306, combined with the first s-bend 326 of the Si waveguide 306, may be referred to as a TM-to-TE polarization rotator as denoted in FIG. 3 as it may perform a TM-to-TE polarization rotation function. For instance, the TM-to-TE polarization rotator may rotate the TM polarization of the TM channel in the first SiN waveguide 302 to TE polarization.

The second s-bend 328 may be referred to as a Si mode filter as it may perform a mode filter function. In particular, the second s-bend 328 or Si mode filter may remove any higher-order modes, which may exist as hybrid modes in the Si waveguide 306, and may still allow for very low transmission loss for the fundamental TE and TM modes.

FIG. 3 additionally includes a table 330 of various example values for some parameters in FIG. 3 according to at least one embodiment. For instance, the tip of the first (and/or second) tapered end 312 (and/or 314) may have a tip width wₜᵢₚ of about 134 nm, which may expand to a width w_{Si} of 350 nm where the first tapered end 312 joins the first s-bend 326. The first (and/or second) SiN waveguide 302 (and/or 304) may have a width w_{SiN} of 1 micrometer (μm), which may be constant along the length of the first (and/or second) SiN waveguide 302 (and/or 304) in some embodiments. Alternatively or additionally, the width w_{SiN} of the first (and/or second) SiN waveguide 302 (and/or 304) may be at least two times the width w_{Si} of the first tapered end 312. The first (and/or second) tapered end 312 (and/or 314) may have a length L1 in the z direction of 200 μm. The first s-bend 326 may have a length L2 in the z direction of 510 μm. The second s-bend 328 may have a length L3 in the z direction of 60 μm. In other embodiments, the parameters of the PSR 300 may have other values than the example values listed in the table 330 and described herein.

FIGS. 4A and 4B include graphical representations 400A, 400B of some simulations associated with the first Si-SiN adiabatic coupler 316 of FIG. 3, arranged in accordance with at least one embodiment described herein. FIG. 4A additionally illustrates the first Si-SiN adiabatic coupler 316 with some of the example parameter values mentioned in connection with the table 330 of FIG. 3.

The graphical representation 400A of FIG. 4A is of a simulation of TE and TM polarization coupling efficiency as a function of L1 (labeled “SiN-Si Splitter length (μm)” in the graphical representation 400A), assuming the other parameter values denoted for the first Si-SiN adiabatic coupler 316 of FIG. 4A. The simulation of the TE and TM polarization coupling efficiency also assumes a wavelength of light propagating through the first Si-SiN adiabatic coupler 316 to be 1.26 μm. Other wavelengths of light may exhibit the same or similar coupling efficiencies.

Curve 402 represents TE coupling efficiency from the first SiN waveguide 302 to the Si waveguide 306 while curve 404 represents TM coupling efficiency from the first SiN waveguide 302 prior to the first Si-SiN adiabatic coupler 316 to the first SiN waveguide 302 after the first Si-SiN SiN adiabatic coupler 316. It can be seen from curves 402 and 404 that the coupling efficiency for each polarization is about 95% at a length L1 of about 200 μm. It can also be seen from the curves 402 and 404 that the coupling efficiency for each polarization is at least 90% for taper lengths of at least 40 μm and is about 95% or higher for taper lengths in a range from about 170 μm to about 240 μm.

The graphical representation 400B in FIG. 4B includes a mode simulation for optical modes in the coupling portion 308 of the first SiN waveguide 302 and in the first tapered end 312 of the Si waveguide 306.

FIG. 4A additionally includes a table 406 of the simulated coupling efficiency of TE and TM polarization input modes to optical modes in the coupling portion 308 of the first SiN waveguide 302 and in the first tapered end 312 of the Si waveguide 306 assuming the light entering the first Si-SiN adiabatic coupler 316 has a wavelength of 1.31 μm. The TE input mostly couples to “Mode1” which is a mode that is mostly confined in the Si waveguide 306 while the TM input mostly couples to “Mode4” which is a mode that is mostly confined in the first SiN waveguide 302.

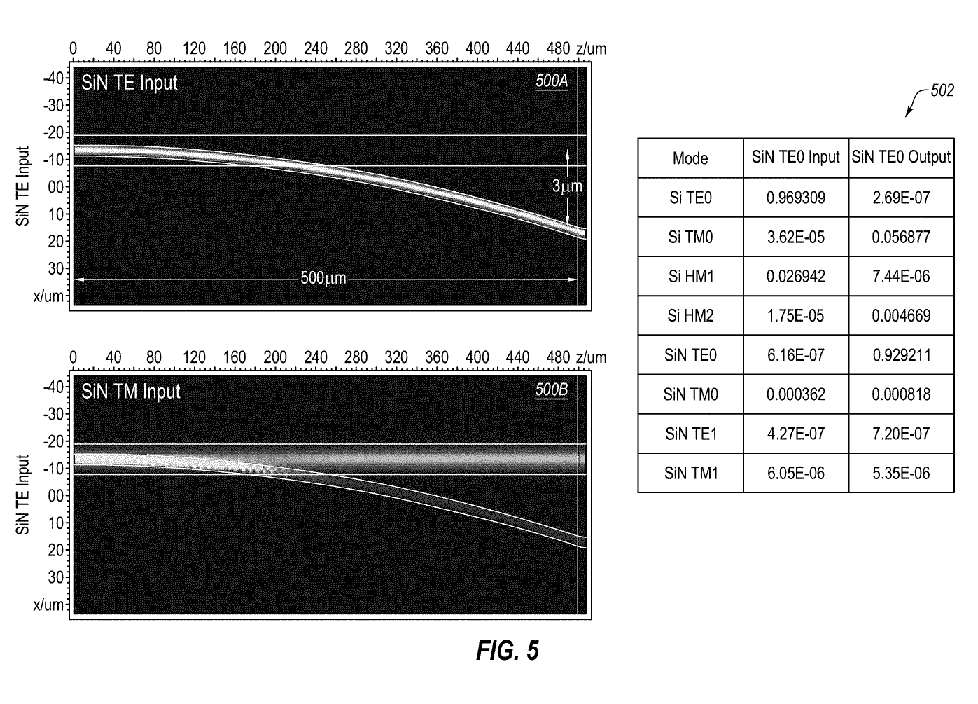

FIG. 5 includes graphical representations 500A, 500B of some simulations associated with the PSR 300 of FIG. 3, arranged in accordance with at least one embodiment described herein. In more detail, the graphical representation 500A simulates TE propagation in a first arc of the first s-bend 326 of the Si waveguide 306 of FIG. 3 and the graphical representation 500B simulates TM propagation in the first SiN waveguide 312 (and partially in the first arc of the first s-bend 326 of the Si waveguide 306). The graphical representation 500A additionally includes various example parameters that may be the same or different in other embodiments.

FIG. 5 additionally includes a table 502 of simulated coupling efficiency of original TE and TM input polarization modes to the modes in the Si waveguide 306 (Si TE0, Si TM0, Si hybrid mode (HM) 1, Si HM2) and the first SiN waveguide 302 (SiN TE0, SiN TM0, SiN TE1, SiN TM1) after the s-bend split (e.g., after the first s-bend 326) of the Si waveguide 306 and the first SiN waveguide 302. After the s-bend split, original TE polarization input (labeled “SiN TE0 input” in table 502) mostly couples to Si TE0 mode and 2-3% of the input couples to Si HM1. Original TM polarization input (labeled “SiN TM input” in table 502) mostly couples to SiN TE0 and 5-6% couples to Si TM0.

In some embodiments, the first s-bend 326 may include two arcs, each with a relatively large but different bend radius. For instance, the first arc of the first s-bend 326 may have a bend radius of 41,668 μm, while a second arc of the first s-bend 326 may have a bend radius of about 833 μm.

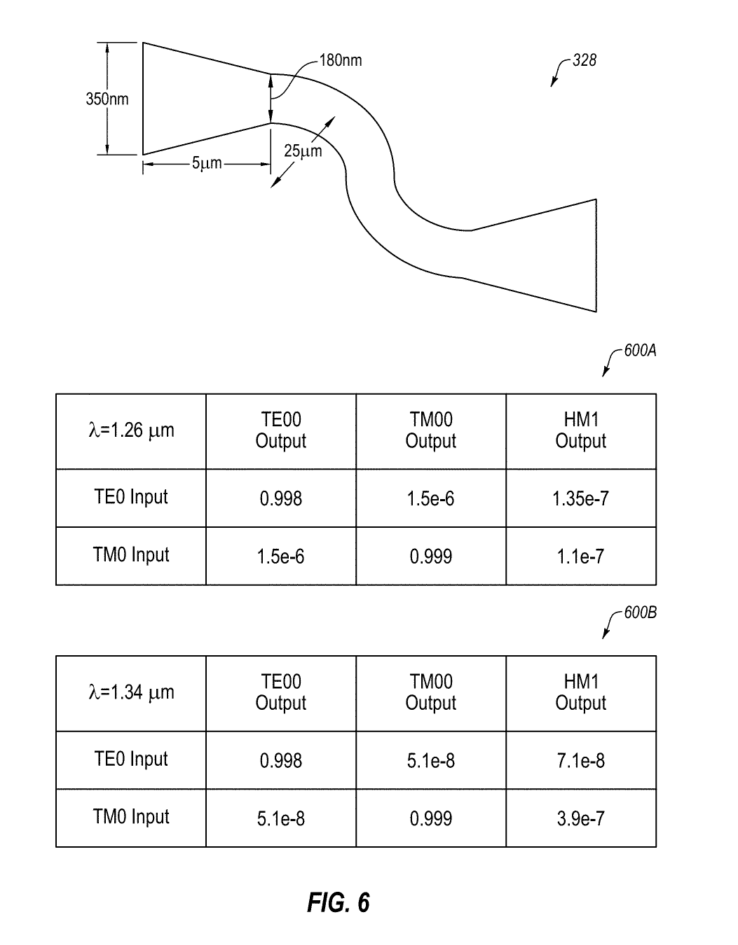

FIG. 6 illustrates an example of the second s-bend 328 of the Si waveguide 306 of FIG. 3, arranged in accordance with at least one embodiment described herein. In an example embodiment, the Si waveguide 306 may generally have a width of 350 nm. However, the width of the Si waveguide 306 may narrow to about 180 nm for the second s-bend 328 in an example embodiment. The Si waveguide 306 may narrow from the width of 350 nm to the width of 180 nm over a length of about 5 μm at an input to the second s-bend 328. Alternatively or additionally, at an output of the second s-bend 328, the Si waveguide 306 may expand from the width of 180 nm to the width of 350 nm also over a length of about 5 μm. One or both arcs of the second s-bend 328 may have a bend radius of 25 μm. In other embodiments, the values of the foregoing parameters may be the same as or different than the foregoing.

FIG. 6 additionally includes tables 600A, 600B of simulated TE, TM, and HM polarization transmission from the second s-bend 328 based on corresponding input polarizations. The simulated polarizations for the table 600A are for light with a wavelength of 1.26 μm while the simulated polarizations for the table 600B are for light with a wavelength of 1.34 μm. The transmission of the fundamental TE and TM modes (that is, TE00 input to TE00 output and TM00 input to TM00 output) is very high while the transmission of TE00 input or TM00 input to HM1 output is very low. This indicates the higher-order mode filtering action by the second s-bend 328. Therefore, the HM1 mode excited by the TE polarization input may be removed after the second s-bend.

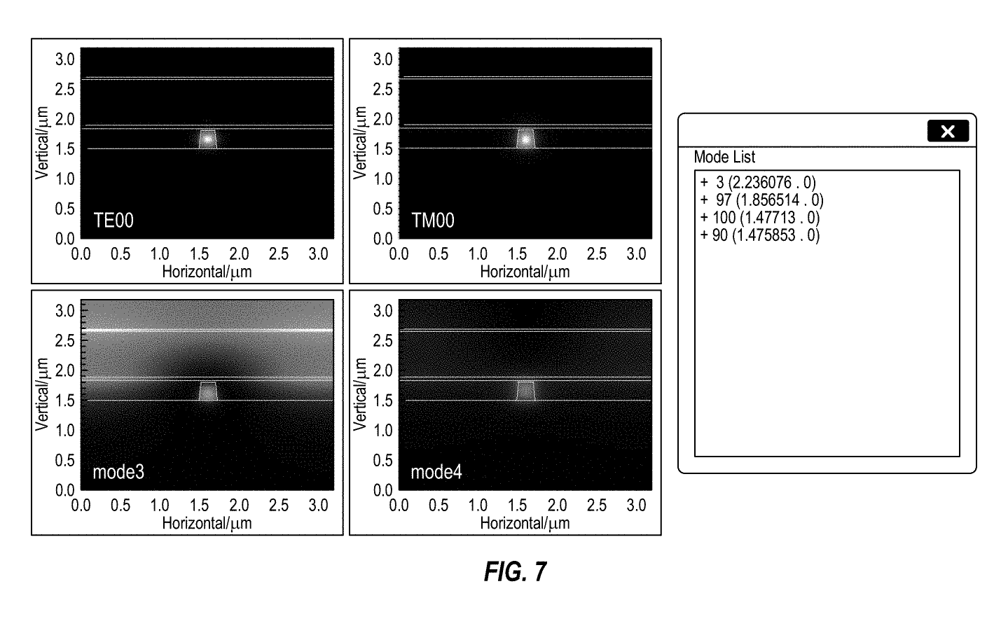

FIG. 7 includes simulated mode profiles for the second s-bend 328 at the input to the second s-bend 328 with a width w_{Si} of the input to the second s-bend 328 being 180 nm, arranged in accordance with at least one embodiment described herein. It can be seen from FIG. 7 that the TE00 and TM00 polarization modes (to the extent there is any TM00 polarization in the second s-bend 328) are substantially confined to the input to the second s-bend 328.

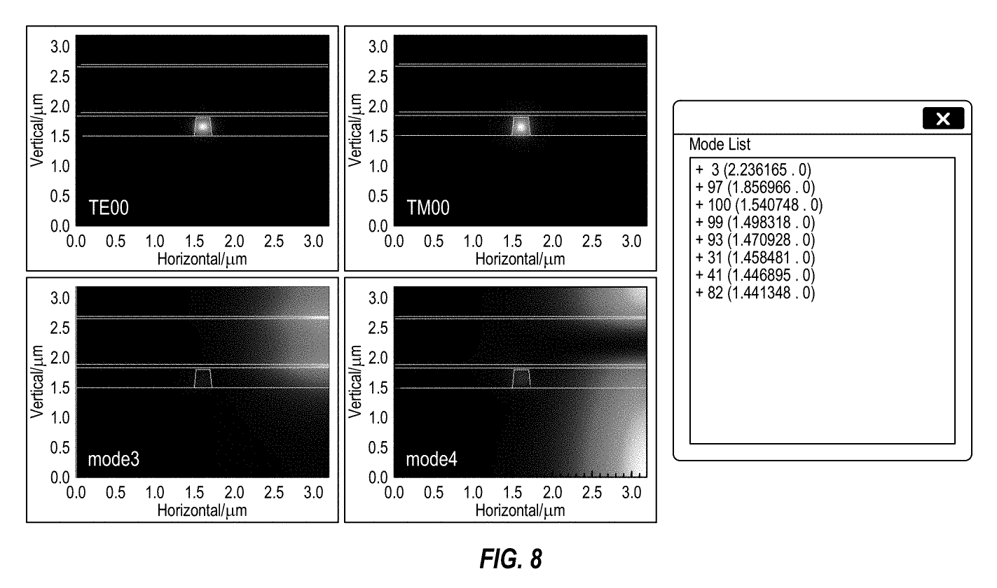

FIG. 8 includes simulated bend mode profiles for the second s-bend 328 in the first arc of the second s-bend 328 with a width w_{Si} of the second s-bend 328 being 180 nm and a bend radius of the first arc being 25 μm, arranged in accordance with at least one embodiment described herein. It can be seen from FIG. 8 that the TE00 and TM00 polarization modes (to the extent there is any TM00 polarization in the second s-bend 328) are substantially confined to the first arc of the second s-bend 328 while higher-order modes are not supported and are radiated away.

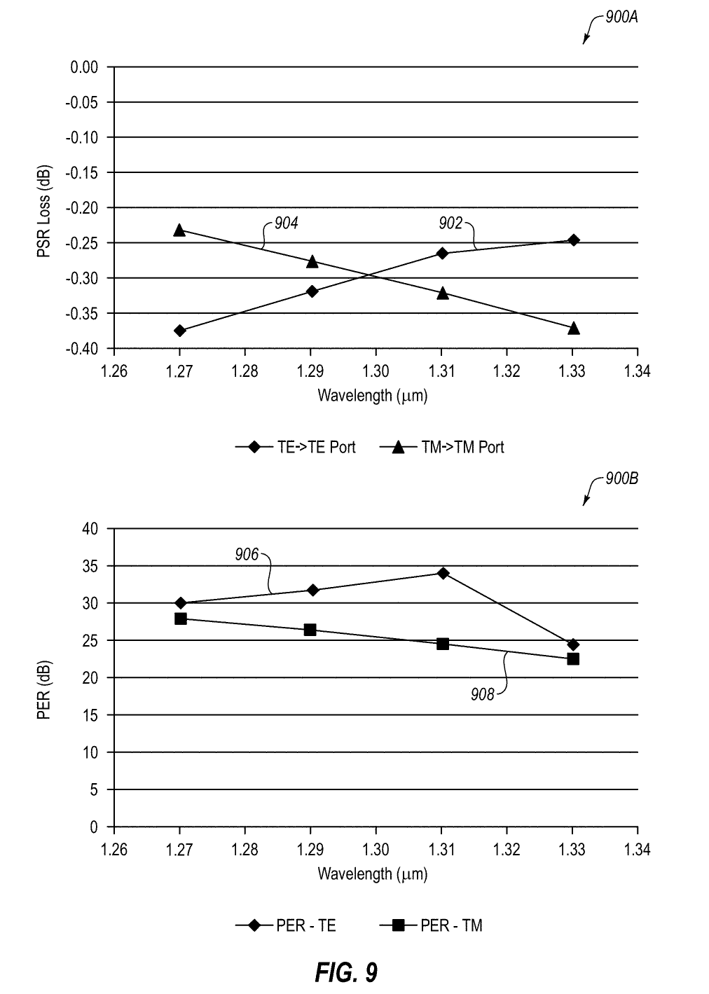

Referring again to FIG. 3, an output of the first SiN waveguide 302 may be referred to as a TM port since it is the primary output of the TM channel, while an output of the second SiN waveguide 304 may be referred to as a TE port since it is the primary output of the TE channel. FIG. 9 includes simulations 900A and 900B associated with the PSR 300 of FIG. 3, arranged in accordance with at least one embodiment described herein.

The simulation 900A is a simulation of optical loss in the PSR (“PSR Loss (dB)” in FIG. 9) as a function of wavelength for both the TE channel (“TE->TE port” in FIG. 9) and the TM channel (“TM->TM port” in FIG. 9). A curve 902 represents the simulation for the TE channel and a curve 904 represents the simulation for the TM channel. As illustrated in FIG. 9, the simulated optical loss does not exceed about 0.37 dB in either channel over a wavelength range of 1.27 μm to 1.33 μm.

The simulation 900B is a simulation of polarization extinction ratio (PER) (“PER (dB)” in FIG. 9) as a function of wavelength for both the TE channel (“PER-TE” in FIG. 9) and the TM channel (“PER-TM” in FIG. 9). A curve 906 represents the simulation for the TE channel and a curve 908 represents the simulation for the TM channel. As illustrated in FIG. 9, the PER exceeds about 22 dB in each channel over the wavelength range of 1.27 μm to 1.33 μm.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A photonic system comprising a silicon (Si) photonic integrated circuit (PIC)-based polarization splitter rotator (PSR), wherein the PSR comprises:
a first silicon nitride (SiN) waveguide formed in a first layer of a Si PIC, the first SiN waveguide having a coupler portion;
a second SiN waveguide formed in the first layer of the Si PIC, the second SiN waveguide having a coupler portion; and
a Si waveguide formed in a second layer of the Si PIC that is above or below the first layer, the Si waveguide including:
a first tapered end near the coupler portion of the first SiN waveguide and adiabatically coupled to the coupler portion of the first SiN waveguide;
a second tapered end near the coupler portion of the second SiN waveguide and adiabatically coupled to the coupler portion of the second SiN waveguide; and
a first s-bend between the first and second tapered ends that cooperates with the first SiN waveguide to form a polarization rotator for light propagating in the first SiN waveguide.

2. The photonic system of claim 1, wherein:
an input beam of light having two orthogonal polarizations is split by the PSR into a TM channel and a TE channel based on the two orthogonal polarizations;
the TM channel is primarily output from the first SiN waveguide;
the TE channel is primarily output from the second SiN waveguide after being transferred from the first SiN waveguide to the Si waveguide and from the Si waveguide to the second SiN waveguide.

3. The photonic system of claim 2, wherein the polarization rotator is configured to rotate a polarization of the TM channel propagating through the first SiN waveguide from TM polarization to TE polarization.

4. The photonic system of claim 1, wherein the second tapered end of the Si waveguide is configured to cooperate with the first end of the second SiN waveguide to form a TM mode filter to substantially filter out at least some TM polarization present in the Si waveguide from being transferred to the second SiN waveguide.

5. The photonic system of claim 1, wherein the Si waveguide further comprises a second s-bend coupled between the first s-bend and the second tapered end.

6. The photonic system of claim 5, wherein a length of the first tapered end is in a range from about 170 micrometers (μm) to 240 μm.

7. The photonic system of claim 6, wherein:
a width of a tip of the first tapered end is in a range between 130 nanometers (nm) and 180 nm; and
a width of the first SiN waveguide is at least two times a width of a widest part of the first tapered end.

8. The photonic system of claim 5, wherein:
the first s-bend comprises a first arc with a bend radius of about 41668 micrometers (μm) and a second arc with a bend radius of about 833 μm; and
the second s-bend comprises first and second arcs each with a bend radius of about 25 μm.

9. The photonic system of claim 1, wherein the second SiN waveguide is laterally spaced apart from and extends parallel to the first SiN waveguide.

10. The photonic system of claim 1, further comprising:
a first wavelength division demultiplexer (WDM demux) formed in the first layer of the Si PIC, wherein the first WDM demux includes a plurality of outputs and an input and wherein the input of the first WDM demux is optically coupled to an output of the first SiN waveguide; and
a second WDM demux formed in the first layer of the Si PIC, wherein the second WDM demux includes a plurality of outputs and an input and wherein the input of the second WDM demux is optically coupled to an output of the second SiN waveguide.

11. The photonic system of claim 10, wherein the first WDM demux comprises a first Echelle grating and wherein the second WDM demux comprises a second Echelle grating.

12. A method, comprising:
receiving an optical signal that includes a first component with a first polarization and a second component with a second polarization that is orthogonal to the first polarization at a coupler portion of a first silicon nitride (SiN) waveguide formed in a first layer of a silicon (Si) photonic integrated circuit (PIC);
adiabatically coupling the second component from the coupler portion of the first SiN waveguide into a first tapered end of a Si waveguide formed in a second layer of the Si PIC that is above or below the first layer while transmitting the first component through the coupler portion of the first SiN waveguide;
rotating the polarization of the first component from the first polarization to the second polarization by transmitting the first component through a portion of the first SiN waveguide that is positioned at least partially above an s-bend formed in the Si waveguide; and
adiabatically coupling the second component from a second tapered end of the Si waveguide that is opposite the first tapered end of the Si waveguide into a coupler portion of a second SiN waveguide formed in the first layer of the Si PIC.

13. The method of claim 12, wherein the s-bend of the Si waveguide comprises a first s-bend, the method further comprising transmitting the second component through a second s-bend coupled between the first s-bend and the second tapered end to remove higher-order optical modes.

14. A photonic system comprising a polarization splitter rotator (PSR), wherein the PSR comprises:
a polarization splitter having an input, a first output for a TM channel, and a second output for a TE channel;
a polarization rotator optically coupled to the first output of the polarization splitter; and
a TM mode filter optically coupled to the second output of the polarization splitter.

15. The photonic system of claim 14, further comprising a higher-order mode filter optically coupled between the polarization rotator and the TM mode filter.

16. The photonic system of claim 14, wherein:
the polarization splitter comprises a first silicon (Si)-silicon nitride (SiN) adiabatic coupler formed in a Si photonic integrated circuit (PIC); and
the TM mode filter comprises a second Si-SiN adiabatic coupler formed in the Si PIC.

17. The photonic system of claim 14, wherein:
the polarization splitter comprises a coupler portion of a first silicon nitride (SiN) waveguide formed in a silicon (Si) photonic integrated circuit (PIC) and a first tapered end of a Si waveguide formed in the Si PIC, wherein the first tapered end of the Si waveguide is aligned in two orthogonal dimensions with the coupler portion of the first SiN waveguide; and
the TM mode filter comprises a coupler portion of a second SiN waveguide formed in the Si PIC and a second tapered end of the Si waveguide, wherein the second tapered end of the Si waveguide is aligned in two orthogonal dimensions with the coupler portion of the second SiN waveguide.

18. The photonic system of claim 17, wherein the polarization rotator comprises:
an s-bend formed in the Si waveguide between the first tapered end and the second tapered end; and
a portion of the first SiN waveguide that overlaps the s-bend in a light propagation direction of the first SiN waveguide, the portion of the first SiN waveguide optically coupled to the first output of the polarization rotator .

19. The photonic system of claim 18, further comprising a higher-order mode filter optically coupled between the polarization rotator and the TM mode filter, wherein the s-bend comprises a first s-bend and the higher-order mode filter comprises a second s-bend formed in the Si waveguide between the first s-bend and the second tapered end.

20. The photonic system of claim 14, further comprising:
a first wavelength division demultiplexer (WDM demux) optically coupled to the polarization splitter, wherein the first WDM demux includes a plurality of outputs and an input and wherein the input of the first WDM demux is optically coupled to the first output of the polarization splitter; and
a second WDM demux optically coupled to the TM mode filter, wherein the second WDM demux includes a plurality of outputs and an input and wherein the input of the second WDM demux is optically coupled to an output of the TM mode filter.
